(19) United States
(12) Patent Application Publication
(10) Pub. No.: US 2011/0271558 A1
(43) Pub. Date: Nov. 10, 2011

(54) LIGHTED PANEL FOR AN ARTICLE OF FOOTWEAR

(75) Inventors: Marc Rosko, Redondo Beach, CA (US); Patrick Warren, Los Angeles, CA (US); Kao-Chang Hung, Redondo Beach, CA (US)

(73) Assignee: Skechers U.S.A., Inc. II, Manhattan Beach, CA (US)

(21) Appl. No.: 12/775,456

(22) Filed: May 6, 2010

(51) Int. Cl. A43B 23/00; A43C 11/00; F21V 21/08

(52) U.S. Cl. 36/137; 362/103; 36/50.1

(57) ABSTRACT

A lighted panel in combination with an article of footwear wherein the lighted panel includes a translucent display panel, a foam sheet, at least one primary light diffuser, and a reflective sheet that together act to illuminate, and distribute light uniformly throughout, the translucent display panel without any concentrated points of light.

### BACKGROUND OF THE INVENTION

1. Field of the Invention

The present invention is a lighted panel for an article of footwear. The lighted panel includes a translucent display panel and diffused lighting means that illuminate substantially the entire display panel in a relatively uniform and even manner without any concentrated points of light. The lighted panel may be located anywhere that illumination is desired on footwear and its to display panel may be relatively large.

2. Description of the Related Art

Prior art devices include United States Patent Application Publication No. US 2006/0221596 A1 to Chang, U.S. Pat. No. 5,860,727 to Chien and U.S. Pat. No. 6,112,437 to Lovitt. While Chang, Chien and Lovitt each involve the use of lighted display panels in connection with footwear unlike the present invention, they do not involve illuminating a relatively large display panel in a relatively uniform manner through the use of various means of light diffusion.

One of the principal shortcomings of prior art lighted display panels is the occurrence of concentrated points of light. The instant invention seeks to eliminate such concentrated points of light through the use of various light diffusing means—a translucent display panel, a foam sheet, at least one primary light diffuser, and a reflective sheet—which together act to distribute light—and therefore illuminate the display panel—more uniformly and evenly.

The primary light diffuser or diffusers themselves also differ from prior art light diffusers. Prior art light diffusers typically diffuse light by a single means such as a faceted surface. By using only one means of diffusion, however, such diffusers are limited in their ability to diffuse light. Typically, they are effective at diffusing light only over a relatively small area. See, for example, U.S. Pat. No. 5,930,921 to Sorofman et al. By using multiple means of diffusion instead of a single means of diffusion, the primary light diffuser(s) in the instant invention provide uniform and even diffusion of light over a relatively large area such as the panel depicted in FIG. 1.

### SUMMARY OF THE INVENTION

The present invention is a lighted panel for footwear wherein light emanates from the panel in a relatively uniform manner without any concentrated points of light. Moving from a location outside the footwear in a direction into the footwear, a typical lighted panel includes, respectively, a translucent display panel, a foam sheet, a primary light diffuser or diffusers, a light source within the primary light diffuser(s), and a reflective sheet. When the light source receives power, light emanates from the light source into the primary light diffuser(s) and diffused light then emanates from the primary light diffuser(s). The light source is powered by a power source.

In a typical embodiment, the footwear is a shoe having a tongue, a closure flap with a hook and loop fastener to secure the shoe to the wearer's foot, and a translucent display panel incorporated in the closure flap. The translucent display panel may include any graphic image such as that of a cartoon character, person, animal, inanimate object or the like. The translucent display panel may also be in any shape, including any irregular shape and any shape where the panel's shape itself is in the form of a character, person, animal, or object. The translucent display panel may also be in the shape of at least one number and/or at least one letter.

A foam sheet between the translucent display panel and the primary light diffuser(s) provides two means of further diffusing the diffused light that emanates from the light source. First, the porosity of the foam sheet assists in light diffusion. Second, the foam sheet provides spacing to keep the primary light diffuser(s) at some distance from the translucent display panel. This spacing assists in diffusion by preventing the occurrence of concentrated points of light that would occur if the light source made contact with the panel. This spacing also assists diffusion by allowing the diffused light to be spread over a broader area than would be the case if the light source were in contact with the panel.

The primary light diffuser(s) are located between the foam sheet and a reflective sheet. The primary light diffuser(s) are made from any translucent material and are typically in the overall shape of a wafer. The primary light diffuser(s) have a top surface, an opposing bottom surface, and a connecting surface that connects the top surface to the bottom surface. The primary light diffuser(s) typically use two or more means to diffuse light that emanates from the light source located within the primary light diffuser. First, the connecting surface may have serrations or other means that diffuse light as it emanates from the primary light diffuser(s). Second, at least the top surface of the primary light diffuser(s) carry a translucent vinyl sheet that diffuses light that emanates from the light source.

The reflective sheet is spaced apart from the translucent display panel due to the presence of the foam sheet and the primary light diffuser(s). The reflective sheet further diffuses light that emanates from the primary light diffuser(s) in two primary ways. First, the reflective sheet's spacing from the translucent display panel allows light that is reflected from the reflective sheet to pass through the foam sheet and to be more broadly spread across the translucent display panel than would be the case if the reflective sheet were closer to the translucent display panel. Second, the reflective sheet is smooth and flexible so that, due to variations in the respective orientations of its reflective surface, it can reflect light in a number of different directions through the foam sheet and across the translucent display panel instead of in a single direction as would be the case if the reflective sheet were smooth, flat and rigid.

### BRIEF DESCRIPTION OF THE DRAWINGS

By way of example only, the present invention is described below in the context of a selected embodiment. Each such description refers to a particular figure (“FIG.”) which shows the described matter. All such figures are shown in drawings that accompany this specification. Each such figure includes one or more reference numerals that identify one or more part(s) or element(s) of the invention. Variations and alternative embodiments of the invention and its components are also described below.

FIG. 1 is an exploded perspective view of a lighted panel for an article of footwear.

FIG. 2A is a top plan view of a primary light diffuser having a slot.

FIG. 2B is a perspective view of a primary light diffuser having a channel.

FIG. 3A is a side elevation view of a primary light diffuser having a serrated connecting surface.

FIG. 3B is a side elevation view of a primary light diffuser having a serrated connecting surface and translucent vinyl sheets on opposite surfaces.

FIG. 3C is a side elevation view of a saucer-shaped primary light diffuser.

FIG. 4 is a schematic representation of multiple primary light diffusers with light sources connected to a power and control unit.

FIG. 5 is a circuit diagram for multiple light sources.

### DESCRIPTION OF A PREFERRED EMBODIMENT

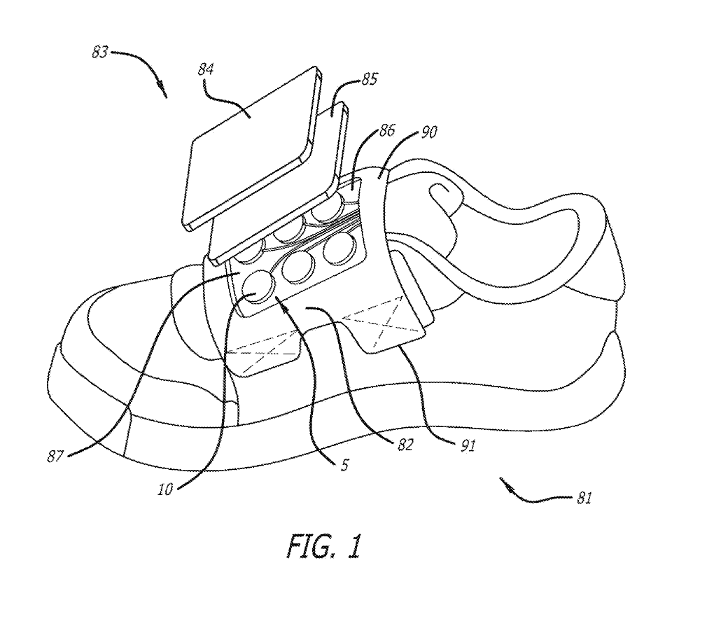

The invention will now be described with reference to the embodiment shown in FIGS. 1-5. This embodiment shows, in FIG. 1, a shoe 81 having a closure flap 82 combined with a lighted panel 83. The closure flap 82 is made of any flexible material and has a medial edge 90 and a lateral edge 91. The medial edge 90 is fixedly attached to the shoe 81 and the lateral edge 91 has a pressure-sensitive fastening means for removably fastening the lateral edge 91 to the shoe 81. Such pressure-sensitive fastening means include a hook-and-loop fastener or the like. The closure flap 82 also has a recessed area 87.

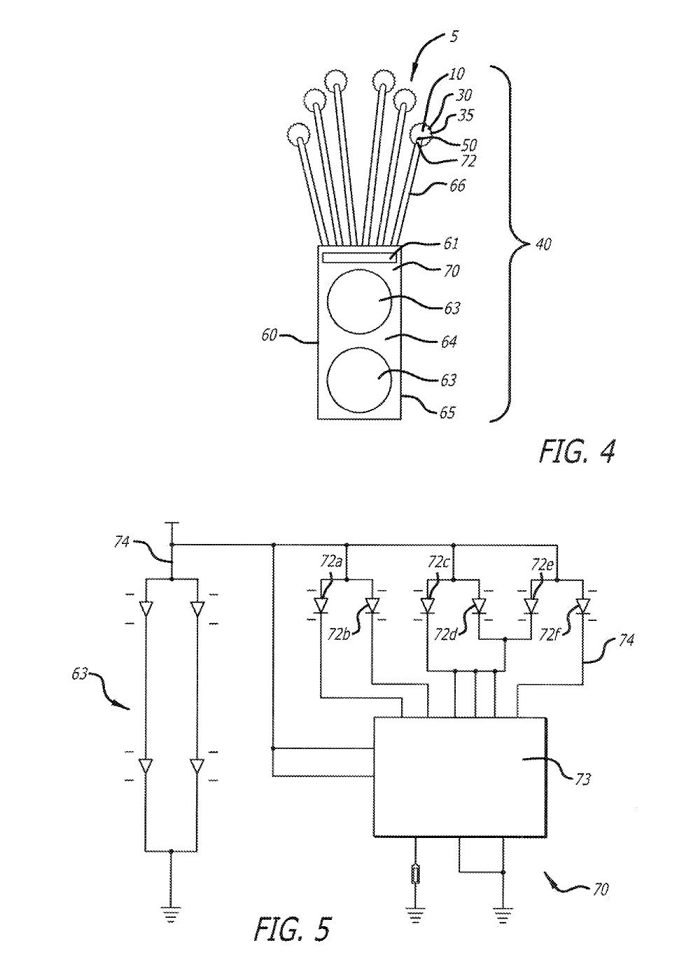

The lighted panel 83 comprises a translucent display panel 84, a foam sheet 85, a reflective sheet 86, and a lighting unit 40. A portion of the lighted panel 83 and a portion of the lighting unit 40 are both shown in FIG. 1. The lighting unit 40 is shown in FIG. 4. The reflective sheet 86 covers substantially the entire recessed area 87. The reflective sheet 86 can be made from any partially or wholly reflective material. The reflective sheet 86 is typically foil or a foil/plastic laminate. The translucent display panel 84 is made from any translucent material. Although any foam can be used to form a foam sheet 83, polyurethane foam identified as CF329 is known to be particularly adept at diffusing light. In lieu of a foam sheet 85, any woven or non-woven porous material may be used since such material would assist in diffusing light by providing spacing between the translucent display panel 84 and a primary light diffuser 5. Such material would further assist in diffusing light because its porosity would tend to spread, disperse, and diffuse light.

The lighting unit 40, as shown in FIG. 4, comprises a power and control unit 60, light source(s) 72 powered by batteries 63, and one or more primary light diffusers 5. Each light source 72 is located within a primary light diffuser 5. The light source 72 is typically a light-emitting diode although any source of light may be used such as a light bulb, optic fiber, or other source. The power and control unit 60 and batteries 63 are typically located in the heel portion of the footwear. The power and control unit 60 includes a box 65, resin 64, batteries 63, a circuit 70, a vibration switch 61 and light source wires 66 that provide power to each light source 72.

A typical circuit 70 for a lighting unit 40 is shown in FIG. 5. It includes a power source in the form of batteries 63, six light sources in the form of six light-emitting diodes 72a, 72b, 72c, 72d, 72e and 72f, circuit wires 74 that provide power to each light source, and an integrated circuit 73 that controls the activation of the light-emitting diodes 72a, 72b, 72c, 72d, 72e and 72f.

In the embodiment shown in FIG. 1, six primary light diffusers 5 are used to illuminate a single translucent display panel 84 located in the closure flap 82 of the shoe 81. The primary light diffusers 5 are located in the recessed area 87 on top of the reflective sheet 86. The foam sheet 85 is located on top of the primary light diffusers 5 and the translucent display panel 84 is located on top of the foam sheet 85. The translucent display panel 84 is fixedly attached to the closure flap 82. This fixed attachment of the translucent display panel 84 to the closure flap 82 keeps the foam sheet 85, primary light diffusers 5, and reflective sheet 86 in substantially the same orientation and location in the recessed area 87 as described above.

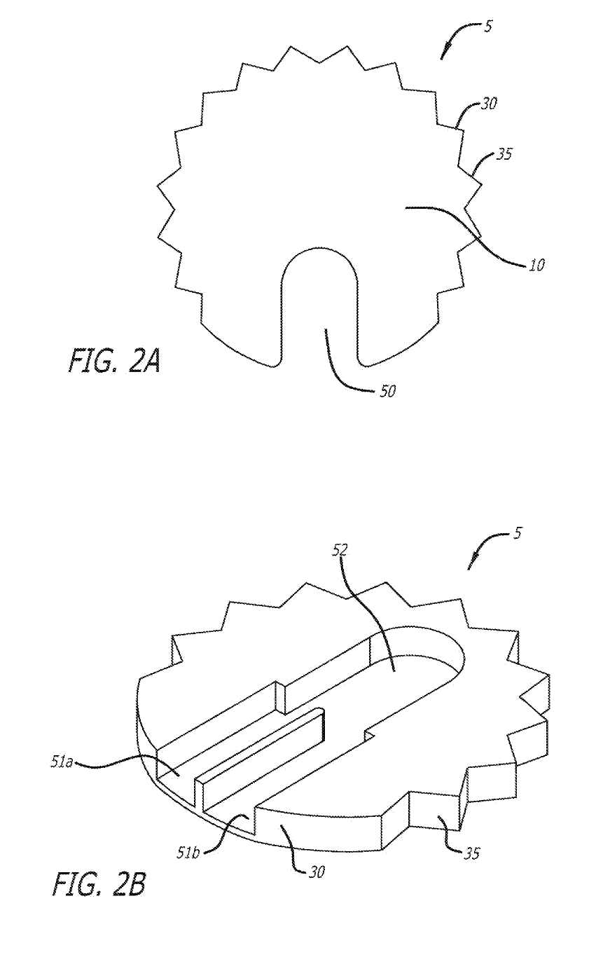

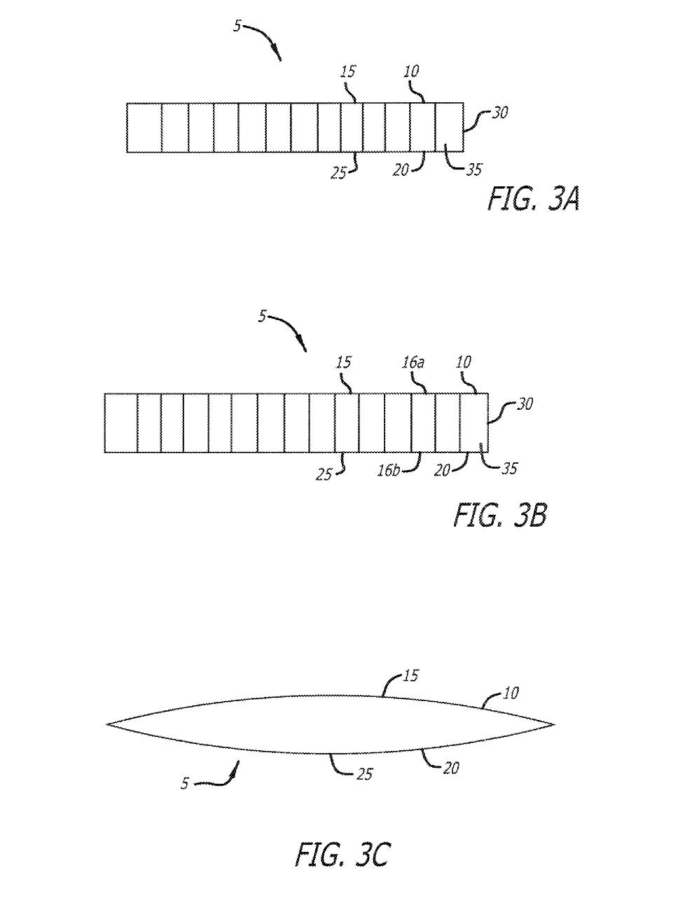

As shown in FIG. 3A, each primary light diffuser 5 has a top surface 10 substantially opposite a bottom surface 20. The top surface 10 faces the translucent display panel 84 and the bottom surface 20 faces the reflective sheet 86. A connecting surface 30 is adjacent to both the top surface 10 and to the bottom surface 20. The primary light diffuser 5 typically has at least two means for diffusing light. In an alternative embodiment, the primary light diffuser may have only one means for diffusing light. In the embodiment shown in FIG. 3A, the primary light diffuser 5 has a first means 15 for diffusing light, a second means 35 for diffusing light, and a third means 25 for diffusing light. In the embodiment shown in FIG. 3B, the primary light diffuser 5 has a first means 15 for diffusing light in the form of a translucent vinyl sheet 16a, a second means 35 for diffusing light, and a third means 25 for diffusing light in the form of a translucent vinyl sheet 16b. As shown in FIGS. 2A, 2B and 3A, the second means 35 of diffusing light is the serrated shape of the connecting surface 30. The serrations in the embodiment shown in FIG. 2B are oriented at approximately 60 degrees to one another. Serrations in other primary light diffuser 5 embodiments may be oriented at other angles with respect to one another.

Any first means 15 of light diffusion, any second means 35 of light diffusion, and any third means 25 of light diffusion can each be any means of light diffusion. A primary light diffuser 5 that has two means of light diffusion can have those two means of light diffusion on any two surfaces 10, 20, 30 of the primary light diffuser 5. A primary light diffuser 5 that has three means of light diffusion can have those three means of light diffusion on any three surfaces 10, 20, 30 of the primary light diffuser 5.

The primary means 15, 25, 35 of light diffusion by the primary light diffuser 5 comprise (a) the shape of a surface 10, 20, 30, (b) the texture of a surface 10, 20 30, and/or (c) any coating applied to a surface 10, 20, 30. A surface 10, 20, 30 that enables light diffusion by its shape is defined herein as a “shaped” surface. Such shaped surfaces 10, 20, 30 may have shapes in the form of serrations, waves, facets, projections, grooves, ridges, irregularities, or other shapes or any combination thereof. When surfaces 10, 20, 30 are shaped, the shape of the surface 10, 20, 30, by itself, enables diffusion. In addition to or in lieu of the shape of a surface 10, 20, 30, the texture of a surface 10, 20, 30 may also enable light diffusion. When the texture of a surface 10, 20, 30 is something other than smooth, the texture of the surface 10, 20, 30, by itself, enables diffusion. A surface 10, 20, 30 that enables diffusion due to the texture of the surface 10, 20, 30 is defined herein as a “textured” surface. A textured surface 10, 20, 30 is any surface that is something other than smooth. For example, surface 10, 20, 30 may be roughened, frosted, sanded, etched, pitted or the like or any combination thereof in order to make it something other than smooth. A surface 10, 20, 30 may become textured by the use of one or more solvents, chemicals, sandpaper, sandblasting, and/or lasers, or the like or some combination thereof. In addition to, or in lieu of, using a shaped surface 10, 20, 30 and/or a textured surface 10, 20, 30 to enable diffusion of light, light diffusion may also be enabled by applying a coating, film, ink, pigment, dye, lacquer, paint, resin, plastic or other composition of matter to a surface 10, 20, 30. Additionally, instead of applying any such composition of matter to a surface 10, 20, 30, the surface 10, 20, 30 may be impregnated with any such composition of matter. Light diffusion enabled by the use of any such applied or impregnated composition of matter is referred to herein as “coating,” “coated” or any form thereof.

A primary light diffuser 5 may have a plurality of light diffusing means that overlap one another on a single surface 10, 20, 30 or that are adjacent to one another on a single surface 10, 20, 30, or a combination thereof. Any means 15, 25, 35 of light diffusion may be used on an entire surface 10, 20, 30. Alternatively, any means 15, 25, 35 of light diffusion may be used on only some portion or portions of a surface 10, 20, 30.

In the embodiment shown in FIGS. 1 and 2A, the primary light diffuser 5 has a slot 50 for holding a light source. In the embodiment shown in FIG. 2B, the primary light diffuser 5 has a pair of channels 51a and 51b that each hold a circuit wire 74, shown in FIG. 5, where each circuit wire is fed into a light source 72 in the form of a light-emitting diode that resides in a light source recess 52. Light that emanates from the light source in this embodiment strikes the first means 15 for diffusing light which is a coating in the form of a translucent vinyl sheet 16a applied to the first surface 10. The translucent vinyl sheet 16a diffuses most of the light that strikes and, passes through it. The translucent vinyl sheet 16a also reflects some of the light that strikes it back inside the primary light diffuser 5. Differing translucent vinyl sheets 16a and 16b can be used to provide differing amounts of diffusion and reflection. Translucent vinyl sheets 16a and 16b that differ from one another in this regard constitute different means 15, 25, 35 of light diffusion.

Each primary light diffuser 5 is made from any material or materials through which light can be transmitted. Such materials include clear or translucent plastic, glass or a combination thereof.

Although the primary light diffuser 5 discussed above has the overall shape of a wafer, the primary light diffuser 5 may be formed in practically any shape including shapes with more than three sides and shapes with only two sides such as a dome or a saucer as shown in FIG. 3C.

Any given article of footwear may have one or more lighted panels 83. Each such lighted panel must have at least one primary light diffuser 5. Each such lighted panel may be in any shape or size and may be located anywhere on the article of footwear.

While the foregoing detailed description sets forth a selected embodiment of a lighted panel in accordance with the present invention, the above description is illustrative only and not limiting of the disclosed invention. Each one of the following claims encompasses a nearly infinite number of embodiments that are within the scope and spirit of the present invention.

What is claimed is:

1. An article of footwear having a closure flap, the closure flap having a lighted panel, the lighted panel comprising:
a reflective sheet adjacent to the closure flap;
a foam sheet facing said reflective sheet;
a translucent display panel facing said foam sheet; and
a lighting unit comprising at least one primary light diffuser located between the reflective sheet and the foam sheet, each primary light diffuser having a light source;
wherein each light source illuminates at least a portion of the translucent display panel.

2. The article of footwear of claim 1 wherein each said primary light diffuser has two opposing surfaces and a serrated connecting surface.

3. The article of footwear of claim 1 wherein said light source is a light emitting diode.

4. The article of footwear of claim 1 wherein the reflective sheet comprises foil.

5. An article of footwear having a lighted panel affixed to the article of footwear, the lighted panel comprising:
a reflective sheet adjacent to the article of footwear;
a porous material facing said reflective sheet;
a translucent display panel facing said porous material; and
a lighting unit comprising at least one primary light diffuser located between the reflective sheet and the porous material, each primary light diffuser having a light source;
wherein each light source illuminates at least a portion of the translucent display panel.

6. The article of footwear of claim 5 wherein each said primary light diffuser has two opposing surfaces and a serrated connecting surface.

7. The article of footwear of claim 5 wherein said light source is a light emitting diode.

8. The article of footwear of claim 5 wherein the reflective sheet comprises foil.

9. The article of footwear of claim 5 wherein the porous material is a foam sheet.

10. The article of footwear of claim 5 wherein the porous material is woven.
